(19) United States
(12) Patent Application Publication
(10) Pub. No.: US 2009/0236025 A1
(43) Pub. Date: Sep. 24, 2009

(54) APPARATUS AND METHODS FOR PRODUCING FOAMED MATERIALS

(75) Inventors: Frank Burkus, Cumming, GA (US); Pascal Laborde, Poissy (FR); Leslie J. Varga, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/408,282

(22) Filed: Mar. 20, 2009

Related U.S. Application Data
(60) Provisional application No. 61/038,873, filed on Mar. 24, 2008.

(51) Int. Cl. B32B 37/12; B29C 44/34; B01F 3/04

(52) U.S. Cl. 156/60; 264/50; 261/64.1

(57) ABSTRACT

Apparatus and methods for producing a foamed material. Pressurized gas is introduced into a multiple-component mixture that contains a catalyst-containing component and a crosslinker-containing component. The multiple-component mixture may be directly mixed and combined with the gas in a mixing device. Alternatively, the multiple-component mixture may be combined in a first mixing device and this mixture may be subsequently combined with the gas in a second mixing device. When dispensed onto an application target, the gas entrained in the multiple-component mixture expands to form the foamed material.

### CROSS-REFERENCE TO RELATED APPLICATIONS

This application claims the benefit of U.S. Provisional Application No. 61/038,873, filed Mar. 24, 2008, the disclosure of which is hereby incorporated by reference herein in its entirety.

### BACKGROUND

The present invention is generally related to apparatus and methods for producing foamed materials.

Single component fluid materials, such as polymeric materials like thermoplastic hot melt adhesives and polymeric coatings, may be foamed before being dispensed. To that end, conventional dispensing systems may inject a gas, such as nitrogen, into solution with a single component polymeric material to transform the polymeric material into a foamed version of the material. Compressed volumes of the compressible gas are entrained in the incompressible polymeric material. When the polymeric material is dispensed and the constraint on expansion is removed, the entrained volumes of gas rapidly expand and are trapped within the polymeric material to generate a foamed fluid material. These trapped cells comprise small bubbles of gas distributed throughout the polymeric material. The resulting foamed polymeric material may then be dispensed onto a target application area.

A benefit of foaming polymeric materials is the reduced weight at equal volume with the same thickness. This benefit is advantageous in several applications, such as the manufacture of motor vehicles like automobiles and the manufacture of aircraft.

Other types of foamed materials may be formed from two or more components that may, for example, chemically react when combined. Materials of this type may, for example, include two-component and three-component adhesives. Foamed multi-component materials may be produced by conventional techniques that rely on a chemical reaction to produce entrained volumes of gas.

Apparatus and methods capable of foaming multi-component materials without the need for a chemical reaction would be desirable.

### SUMMARY

In one embodiment, a method is provided for producing a foamed material from a catalyst-containing component, a crosslinker-containing component, and a gas. The method includes mixing the catalyst-containing component and the crosslinker-containing component to form a mixture, mechanically mixing the gas with the mixture, and dispensing the mixture as the foamed material. The gas is entrained in the mixture and, when dispensed, expands to form the foamed material. The purely mechanical approach for foaming the catalyst-containing component and the crosslinker-containing component by introducing a gas overcomes various disadvantages of conventional approaches that rely on a chemical reaction to form the entrained gas. Generally, foamed multi-component materials may, for example, be desirable in aircraft manufacturing as their use as a replacement for identical non-foamed materials reduces the weight of material used for bonding aircraft components.

In another embodiment, an apparatus is provided for producing a foamed material from first and second fluid components and a gas. The apparatus includes a mixing device having a mixing chamber, a first inlet communicating with the mixing chamber, a second inlet communicating with the mixing chamber, a gas port communicating with the mixing chamber, and a mixing element inside the mixing chamber. The first and second inlets are configured for respectively admitting the first and second fluid components into the mixing chamber. The apparatus further includes a gas flow control valve coupled to the gas port and configured for introducing the gas through the gas port into the mixing chamber. The mixing element is configured to mix the first and second fluid components with the gas inside the mixing chamber to form a mixture that, when dispensed, produces the foamed material. The mixing device mechanically mixes the gas with the first and second fluid components, which eliminates the need to rely on a chemical reaction to provide the entrained gas.

In yet another embodiment, an apparatus is provided for producing a foamed material from first and second fluid components and a gas. The apparatus includes a first mixing device having a first mixing chamber and a first mixing element inside the first mixing chamber. The first mixing element is configured to mix the first and second fluid components. The apparatus further includes second mixing device having a second mixing chamber coupled in fluid communication with the first mixing device for receiving the first and second fluid components from the first mixing device, a second mixing element inside the second mixing chamber, and a port configured to provide access into the mixing chamber. A gas flow control valve is coupled with the port and is configured for introducing the gas into the first and second fluid components in the second mixing chamber. The second mixing element is configured to mix the first and second fluid components with the gas inside the second mixing chamber to form a mixture that, when dispensed, produces the foamed material.

### BRIEF DESCRIPTION OF THE DRAWINGS

FIG. 1 is a schematic view of a dispensing system in accordance with an embodiment of the invention;

FIG. 2 is a schematic view of a dispensing system in accordance with another embodiment of the invention;

FIG. 3 is a perspective view of an exemplary mixing device that may be used in the dispensing system of FIG. 2;

FIG. 4 is a cross-sectional view taken generally along line 4-4 of FIG. 3;

FIG. 5 is a broken away, cross-sectional view of another exemplary mixing apparatus that may be used in the system of FIG. 2;

FIG. 6 is a perspective view of a gas infeed device of the mixing apparatus of FIG. 5;

FIG. 6A is a cross-sectional view taken generally along line 6A-6A of FIG. 6;

FIG. 7 is a broken away, enlarged cross-sectional view of a portion of the gas infeed device of FIGS. 6 and 6A;

FIG. 8 is a broken away, enlarged cross-sectional view of a mid-portion of the gas infeed device of FIGS. 6, 6A, and 7, showing a needle tip thereof in a first position relative to a sealing seat;

FIG. 9 is a view similar to FIG. 8 showing the needle tip in a second position different from that shown in FIG. 8;

FIG. 10 is a broken away, enlarged cross-sectional view of an end portion of the gas injection module of FIGS. 6-9; and

FIG. 10A is an enlarged view of encircled area 10A of FIG. 10.

### DETAILED DESCRIPTION

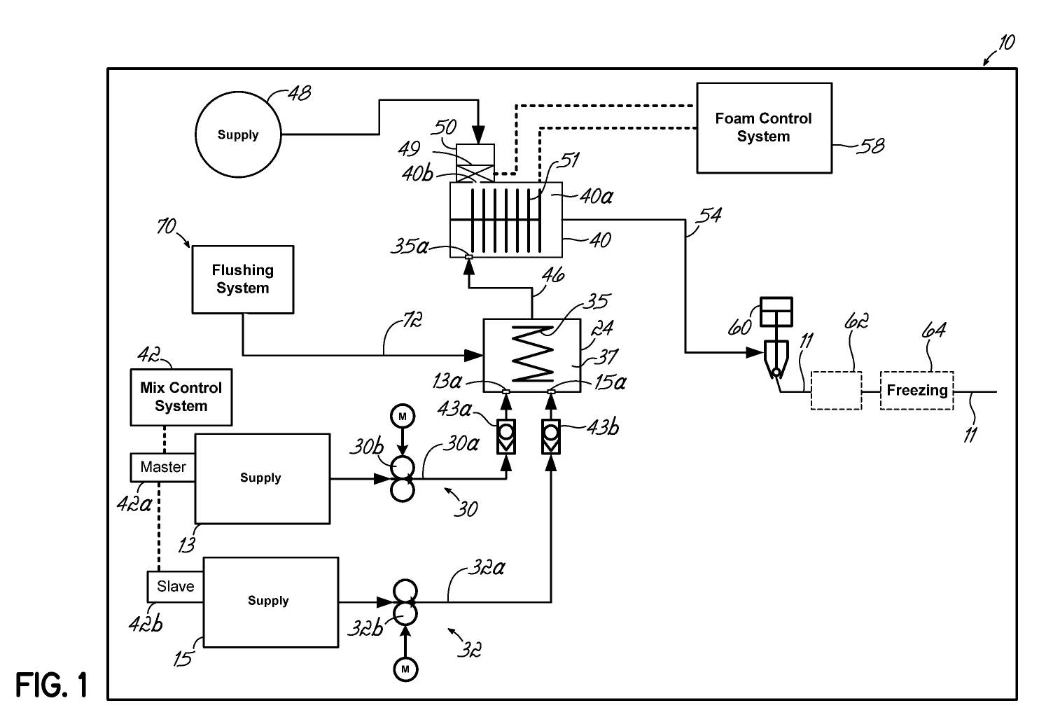

With reference to FIG. 1 and in accordance with an embodiment of the invention, a dispensing system 10 is used to produce a foamed material 11 incorporating a gas and a multiple-component material. A first fluid component of the multiple-component material is in the form of at least one base resin which may incorporate a catalyst, an accelerator, an initiator, or another reactive species. The base resin may be a homopolymer, a copolymer, or a polymer blend. Representative base resins may include, but are not limited to, silicones, acrylics, epoxies, polysulfides, and urethanes. The number of components may include, but are not limited to, two-component materials, three-component materials, or other multi-component blends and the reaction mechanism(s) may include, but are not limited to, addition curing, radical curing and other curing chemistries. A second fluid component of the multiple-component material, which is separate and distinct from the first component, contains a base resin and a multifunctional reactive species that can serve as a crosslinker. Generally, the crosslinker is a compound (polymer or single molecule species) that has multiple functionality as reactive groups. The multiple functionality, once reacted with the base resin, results in a three-dimensional network, thereby forming a final product. The crosslinker may be an organic substance or an inorganic substance contingent upon the specific polymer system. As an example, a suitable crosslinker for an epoxy base resin is typically organic while a suitable crosslinker for a silicone base resin is typically inorganic.

As used herein, the first fluid component is referred to as a catalyst-containing component and the second fluid component is referred to as the crosslinker-containing component. With regard to the catalyst-containing component, it is understood that the component may contain an accelerator, an initiator, or another reactive species instead or, or in addition to, a catalyst. The isolation of the catalyst in the catalyst-containing component from the crosslinker in the crosslinker-containing component prevents curing.

The first and second fluid components are stored in isolation from each other to preclude chemical reaction leading to crosslinking and are only combined shortly before the time of use. When combined together, a chemical reaction initiates and curing occurs to form a cured product. Specifically, the crosslinker in the crosslinker-containing component reacts with the catalyst in the catalyst-containing component to form a polymer network via one or more of numerous reactions depending on the specific catalyst and reactant structure. However, the combination of the catalyst-containing component with the crosslinker-containing component either does not result in a chemical reaction that produces gas or chemically reacts to produce only a negligible amount of gas that is insufficient in and of itself to result in a measurable change in the dispensed weight.

The dispensing system 10 of the representative embodiment includes a first mixing device in the form of a static mixer 24 that is operatively coupled to first and second feeding devices 30, 32. For example, the feeding devices 30, 32 may include respective conduits or lines 30a, 32a and respective pumps 30b, 32b that withdraw amounts of the first and second fluid components from respective supplies 13, 15 and direct the withdrawn the respective first and second fluid components through the lines 30a, 32a, through the static mixer 24. The pressurization supplied by the pumps 30b, 32b forces the mixture of the first and second fluid components from the static mixer 24 toward a second mixing device in the form of a dynamic mixer 40. Specifically, the feeding devices 30, 32 respectively feed the first and second fluid components from the respective supplies 13, 15 into a mixing chamber 37 of the static mixer 24 through respective ports 13a, 15a of the static mixer 24.

In the representative embodiment, a control system 42 regulates the rate and/or amounts of the first and second fluid components that are fed through feeding devices 30, 32 and may include, without limitation, master and slave components 42a, 42b that cooperate in this regard to maintain an appropriate mixture. Check valves 43a, 43b are respectively disposed in lines 30a, 32a to selectively permit or restrict flow of the first and second fluid components into the static mixer 24.

The static mixer 24 includes a mixing element 35, which is located inside the mixing chamber 37, that is operative to mix the first and second fluid components with one another to form a mixture. Conventional static mixers, which have no moving parts, are devices having a series of internal baffles or elements, such as a series of alternating right- and left-hand helical elements oriented at right angles to one another. Representative static mixers are disclosed in commonly-assigned U.S. Pat. No. 5,480,589, the disclosure of which is incorporated by reference herein in its entirety. For example, and without limitation, the dynamic mixer 40 may be of a type commercially known under the name Ultra FoamMix and available from Nordson Corporation of Westlake, Ohio. The mixing chamber 37 of the static mixer 24 is connected through a line 46 with an inlet 35a of a mixing chamber 40a of the dynamic mixer 40. The mixture is routed from the mixing chamber 37 of the static mixer 24 to the mixing chamber 40a of the dynamic mixer 40.

A pressurized gas, such as nitrogen, dry air, or an inert gas, is fed from a supply 48 into the mixing chamber 40a through a gas infeed device 50. The gas from the supply 48 is supplied into the mixing chamber 40a of the dynamic mixer 40 through a port 40b, which provides fluid access into the mixing chamber 40a. The flow of the gas through port 40b into the mixing chamber 40a of the dynamic mixer 40 may be regulated by a gas flow control valve 49 of the gas infeed device 50. Typically, the pressure of the gas being introduced into the mixing chamber 40a is maintained higher than the fluid pressure of the mixture inside the mixing chamber 40a so that the gas flows into the mixing chamber 40a. Generally, the specific gas pressure will depend on the viscosity and flow rate of the mixture. As used herein, the process of mechanically injecting the gas into the mixture refers to the use of a mechanism to inject the gas into the mixture, in contrast to a chemical process that generates the gas from a chemical reaction.

The dynamic mixer 40 includes a mixing element 51 inside the mixing chamber 40a that combines the gas with the first and second fluid components of the multiple-component material. Representative dynamic mixers are disclosed in commonly-assigned U.S. Pat. No. 4,778,631, the disclosure of which is incorporated by reference herein in its entirety. As used herein, the process of mechanically mixing the gas with the mixture refers to the use of a either a static or moving mixing element to accomplish the requisite mixing to form a mixture that can be ultimately dispensed as a foamed material.

The material mixture containing the entrained gas exits an outlet of the dynamic mixer 40 through an outlet line 54 and is directed to a dispensing device 60. The dispensing device 60 dispenses the foamed material 11 directly onto an application target, such as a substrate or another structural component (not shown). For example, the foamed material 11 may be applied to a first structural component of an aircraft and used to bond the first component with a second structural component of the aircraft. As specific examples, the foamed material 11 may be used as a fuel tank sealant, a windshield sealant, a firewall sealant, an electric potting compound, a conductive sealant, or as an aerodynamic and corrosion inhibitive sealant.

Dispensing device 60 is configured in a manner understood by a person having ordinary skill in the art to dispense the foamed material in discrete volumes, such as beads or dots, to provide an interrupted, non-continuous pattern on a moving substrate, or to dispense the foamed material as continuous beads or stripes. The dispensing device 60 may comprise a gun, a module, a hand gun, etc. For example, and without limitation, dispensing device 60 may take the form of a dispensing gun known under model AG900, which is available from the Nordson Corporation of Westlake, Ohio. In one specific embodiment, the dispensing device 60 may be any conventional hot melt dispenser, including but not limited to needle valve-type dispensers, capable of selectively actuating a needle tip relative to a sealing seat for intermittently discharging amounts of the mixture the multi-component material and entrained gas from a discharge orifice and providing a positive flow cutoff. The dispensing device 60 may be pneumatically actuated by the operation of a solenoid valve that supplies air pressure to an air cylinder for moving the valve stem away from the sealing seat, thereby allowing the mixture the multi-component material and entrained gas to flow to the discharge orifice. Alternatively, the dispensing device 60 may be electrically operated and include a coil that generates an electromagnetic field for moving an armature relative to a stationary pole, in which the stem is physically coupled with the armature for moving the valve stem relative to the sealing seat. The discharge orifice of the dispensing device 60 may be defined in a nozzle that may be readily removed and exchanged with other similar nozzles for varying the configuration of discharge orifice to dispense amounts, streams, dots or beads of the multi-component material and entrained gas characterized by a different size and/or a different shape for the foamed material 11 on the substrate. The dispensing device 60 may also include a trigger that is manually actuated to initiate dispensing.

A foam control system 58 controls the operation of the dynamic mixer 40 and may control, for example and without limitation, the flow of gas from supply 48 into the dynamic mixer 40 via the gas flow control valve 49 and/or the flow of the material out of the dynamic mixer 40. The foam control system 58 is electrically coupled with the gas flow control valve 49 for this purpose.

When the mixture of multi-component material and entrained gas is dispensed from the dispensing device 60, the discrete volumes of gas rapidly expand and are trapped, following expansion, within the volume of the multi-component material to generate the foamed material 11. The trapped closed cells comprise small bubbles of gas distributed throughout the bulk of the foamed material 11 and provide a structure of closed cells in the cured material. The bubble distribution may be homogeneous or inhomogeneous depending upon, among other variables, the type of base resin, the desired density reduction, the residence time in the mixing chamber 40a of dynamic mixer 40, and the flow rate of the mixture of the first and second fluid components. The gas bubbles displace a percentage of the multi-component material to define cells and yield a weight reduction of the cured product, as well as to alter/improve the mechanical properties of the cured product.

In an alternative embodiment, the dispensing device 60 may dispense the foamed material 11 into a temporary holding container, such as a cartridge 62, for storage and subsequent dispensing. The foamed material 11 dispensed into the cartridge 62 may be frozen (as schematically illustrated by box 64) to permit storage in the cartridge 62 and subsequently heated to thaw the frozen foamed material to a dispensable condition and permit dispensing of the foamed material 11 from the cartridge 62. The curing of the material is suspended at the temperatures characteristic of the frozen condition. While frozen, the gas may be retained within the mixture of the first and second fluid components such that the foamed condition is maintained during storage and survives until the material is unfrozen and dispensed.

After or during use, it may be necessary to clean one or more of the components of system 10. System 10 may be cleaned using a schematically illustrated flushing system 70, which may be coupled to one or more of the components of system 10. In particular, flushing system 70 may dispense a cleaning agent such as a solvent 72 having a suitably chosen density to facilitate purging of residual portions of the first and second fluid components through and out of system 10. While the exemplary embodiment of FIG. 1 is shown having a single flushing system 70 coupled only to the static mixer 24, it is contemplated that other embodiments may include any number of flushing systems that may be connected to static mixer 24 and/or to any other components of a foamed producing system. Flushing may be desirable when changing the type of multi-component material being dispensed.

The mix control system 42 and the foam control system 58 may each have a processor (not shown), which may be any suitable conventional microprocessor, microcontroller or digital signal processor, configured to execute software that implements control algorithms to permit the operation. The control systems 42, 58 may also have a memory (not shown) used to store programmed instructions for the processor, as well as user input/output devices. The control systems 42, 58 may be integrated into a single control system.

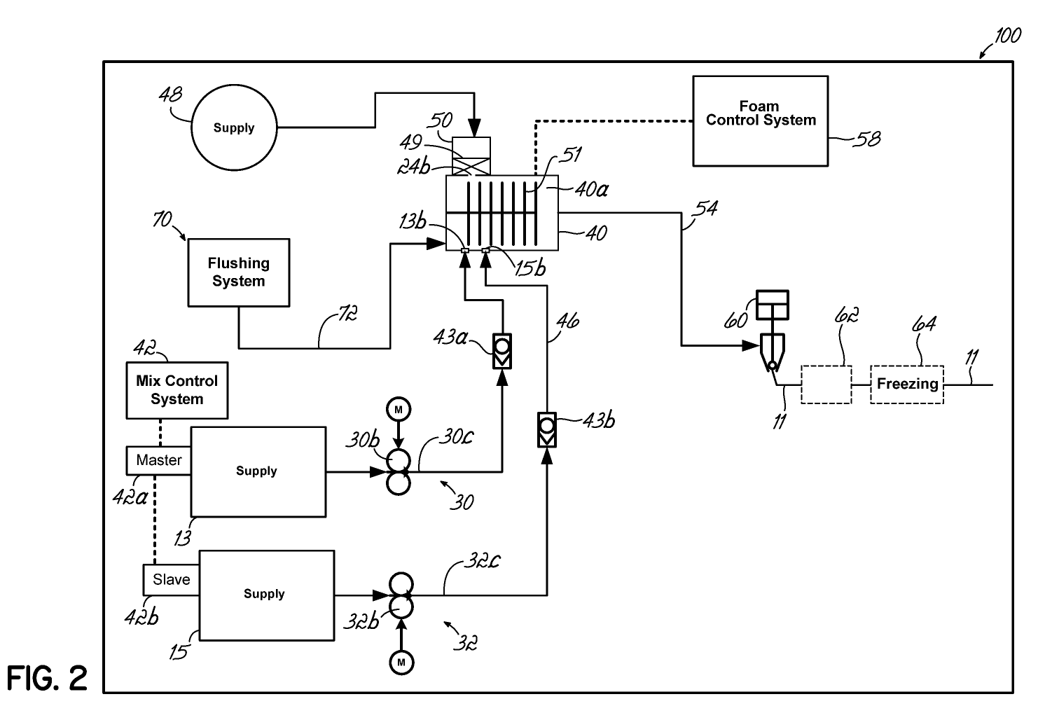

With reference to FIG. 2 in which like reference numerals refer to like features in FIG. 1 and in accordance with an alternative embodiment, a system 100 otherwise similar to system 10 (FIG. 1) includes conduits or lines 30c, 32c that respectively feed the first and second fluid components directly into the interior of the dynamic mixer 40 through respective inlets 13b, 15b, without first mixing in a static mixer or another like device. In this regard, lines 30c, 32c are fluidly coupled with dynamic mixer 40 to feed polymeric components directly into the mixing chamber 40a of the dynamic mixer 40. The mixing element 51 of the dynamic mixer 40, in turn, mixes the gas and the first and second fluid components with one another to form a mixture. Foam control system 58 may control the flow of gas from supply 48 and/or fluid components from supplies 13, 15 into the mixing chamber 40a of dynamic mixer 40 prior to, during, and/or subsequent to mixing of the first and second fluid components with one another in the dynamic mixer 40.

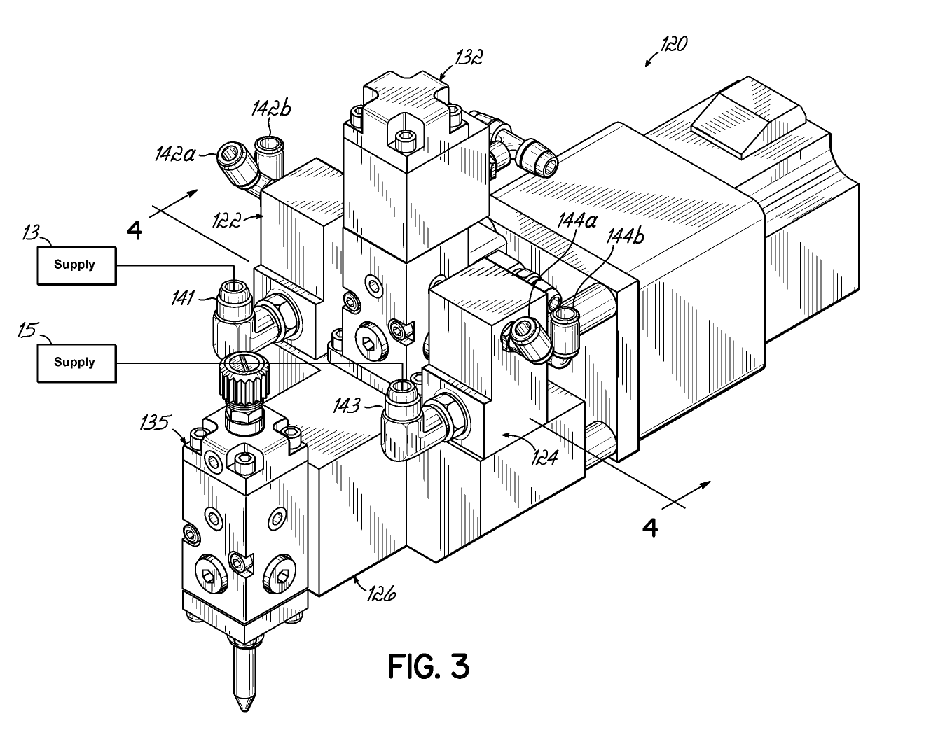

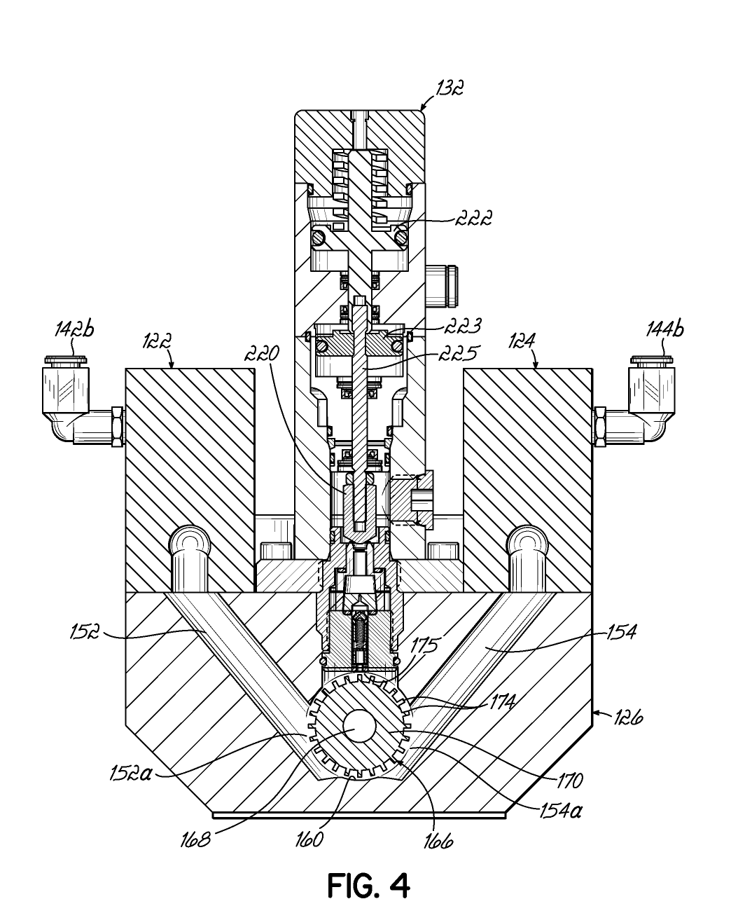

With continued reference to FIG. 2 and further referring to FIGS. 3-4, details are shown of an exemplary dynamic mixer in the form of a mixing device or apparatus 120. Mixing apparatus 120 mixes the first and second fluid components from the supplies 13, 15 and the gas from the supply 48 to thereby produce the foamed material 11 (FIG. 2). The apparatus 120 includes first and second modules 122, 124 respectively controlling supplies of the first and second fluid components into a mixing module 126. A gas infeed device or gas flow control valve in the form of a gas injection module 132 controls supply of the pressurized gas, such as nitrogen, dry air, or an inert gas, into the interior of the mixing module 126. The mixing apparatus 120 is fluidly coupled to and feeds material containing the entrained gas to a dispenser 135, which in turn applies the foamed material 11 onto a desired target.

The first module 122 is fluidly coupled to the supply 13 of the first component through an elbow fitting 141. Elbow fitting 141 may be of a quick-release type to facilitate coupling with the supply 13 of the first fluid component or it may alternatively be of any other type such as one including a threaded coupling. Air fittings 142a, 142b fluidly couple the first module 122 with a source of process air to pressurize the interior of the first module 122 and thereby facilitate supplying the first component to the mixing module 126. The second module 124 similarly includes an elbow fitting 143 and air fittings 144a, 144b respectively similar in structure and/or function to the elbow fitting 141 and air fittings 142a, 142b associated with the first module 122. Second module 124 is fluidly coupled to the supply 15 of the second fluid component.

With specific reference to FIG. 4, first and second internal conduits 152, 154 respectively fluidly couple the first and second modules 122, 124 with the mixing module 126. More particularly, the first and second conduits 152, 154 extend from the respective interiors of the modules 122, 124 to a mixing chamber 160 of the mixing module 126. The conduits 152, 154 access the mixing chamber 160 through respective inlet ports 152a, 154a.

A mixing element 166 extends within the mixing chamber 160 and rotates to mix the first and second fluid components and the pressurized gas with one another to thereby form the gas-entrained multiple-component material. To this end, the mixing element 166 includes a central shaft 168 coupled for rotation to a motor (not shown) and a generally cylindrical body 170 attached to the shaft 168. The cylindrical body 170 includes fins 174 that are helically arranged such that, during continuous rotation of the mixing element 166, the fins 174 tend to force the components 13, 15 toward the inlet ports 152a, 154a, thereby retarding the flow of the gas-entrained material toward an outlet port (not shown) coupled to the dispenser 135. The fluid components flowing through the mixing chamber 160 and the incoming pressurized gas are therefore repeatedly divided by the fins 174 into minor streams and then recombined, thus creating a substantially homogeneous blend or mixture in the mixing chamber 160.

The inlet ports 152a, 154a intersect the mixing chamber 160 near the upstream end of the mixing element 166. In one embodiment, the inlet port 152a is used to introduce the first fluid component and is located upstream of the inlet port 154a used to introduce the second fluid component. This provides a purging or flushing action of the second fluid component through the mixing chamber 160.

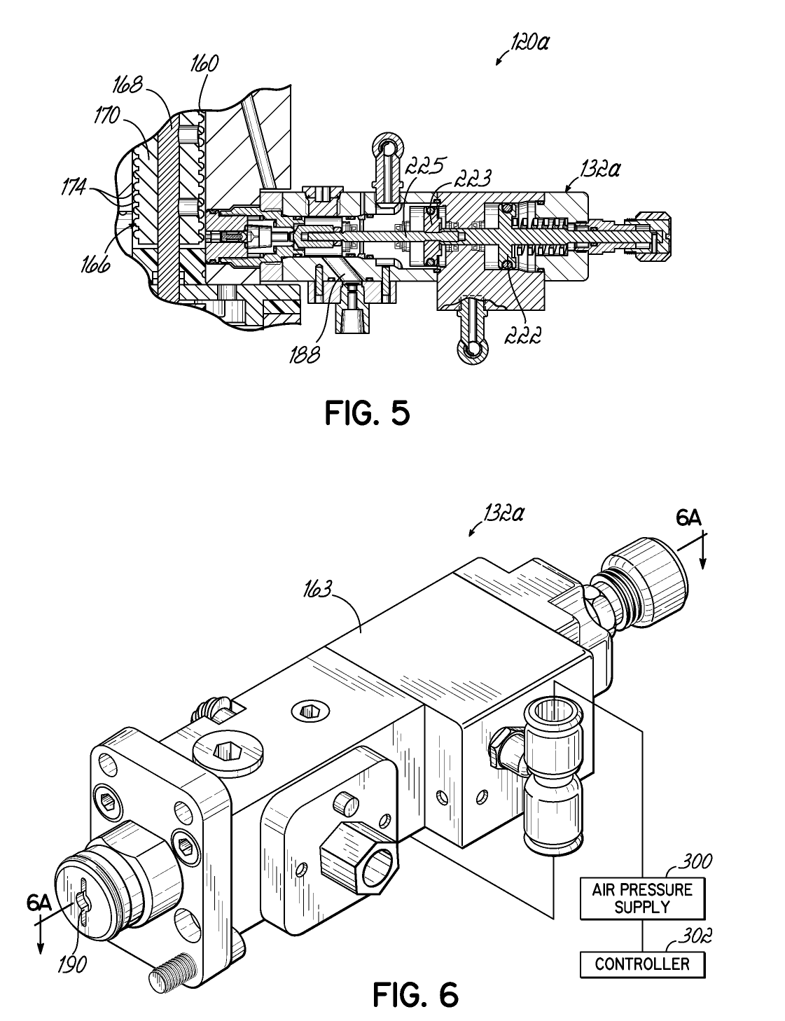

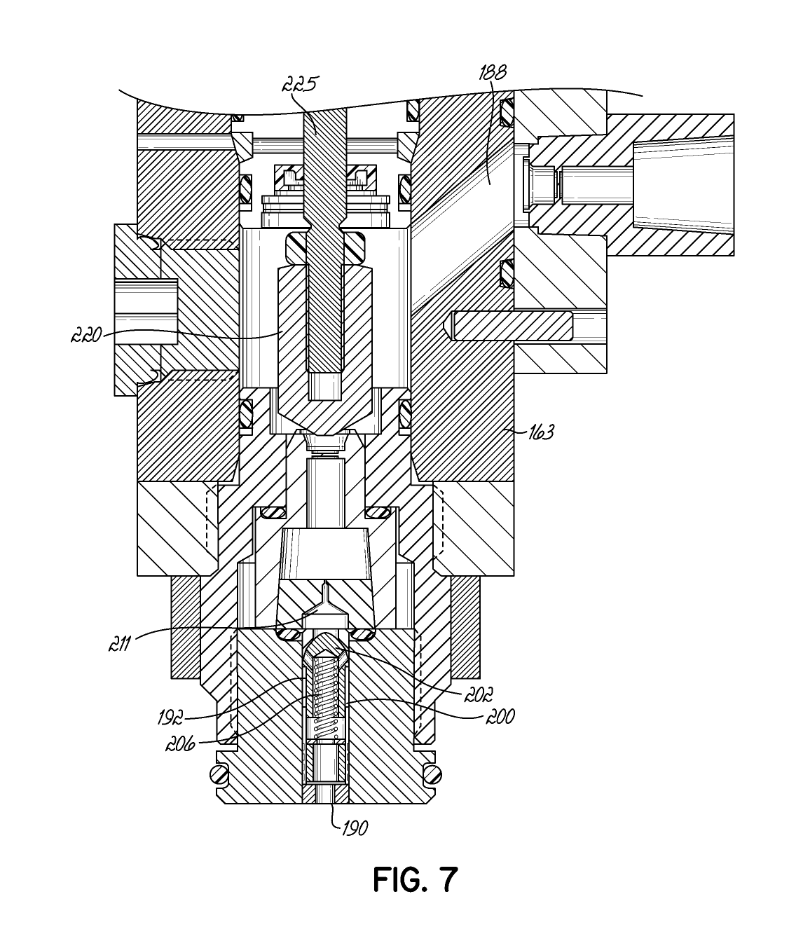

As discussed above, the gas injection module 132 injects the pressurized gas through a gas port 175 into the mixing chamber 160. The gas is mixed or blended with the first and second fluid components in the mixing chamber 160. In this regard, and with reference to FIGS. 5-10A, an alternative gas injection module 132a is similar in most respects to gas injection module 132 (FIGS. 3, 4) and forms part of a mixing apparatus 120a that is also similar in most respects to mixing apparatus 120 (FIGS. 3, 4). For ease of explanation, like reference numerals in FIGS. 5-10A refer to like features of the preceding figures. In this embodiment, the gas injection module 132a has a main body 163 having an inlet 188 configured to receive the pressurized gas from the supply 48, an outlet 190 coupled with the mixing module 126, and a gas passage 192 between the inlet 188 and outlet 190. The gas injection module 132a is configured to communicate the pressurized gas from the inlet 188 through the gas passage 192 to the outlet 190 and from the outlet 190 into the mixing chamber 160. A control orifice 194 in the gas passage 192 is configured to meter a flow rate of the pressurized gas to the outlet 190. To this end, the control orifice 194 may, for example, have an effective diameter of about 0.001 inches to about 0.002 inches.

With continued reference to FIGS. 5-10A, the gas injection module 132a of this embodiment also includes a flow control element 200 in the gas passage 192. The flow control element 200 has a first condition in which the pressurized gas can flow in the gas passage 192 from the inlet 188 through the control orifice 194 to the outlet 190, and a second condition in which the pressurized gas is blocked from flowing to the outlet 190. The flow control element 200 may be located in the gas passage 192 between the control orifice 194 and the outlet 190. In this representative embodiment, the flow control element 200 includes a plunger 202, a seat 204 between the outlet 190 and the control orifice 194, and a biasing element such as a spring 206 that applies a biasing force that urges the plunger 202 into contact with the seat 204. The plunger 202 is thus movable relative to the seat 204 to provide the first and second conditions above described.

The plunger 202 is movable relative to the seat 204 to provide the first condition when a fluid pressure between the plunger 202 and the inlet 188 exceeds a sum of the biasing force provided by the spring 206 and a fluid pressure between the plunger 202 and the outlet 190. The plunger 202 is further movable to provide the second condition described above when the fluid pressure between the plunger 202 and the outlet 190 exceeds the sum of the biasing force provided by the spring 206 and the fluid pressure between the plunger 202 and the inlet 188.

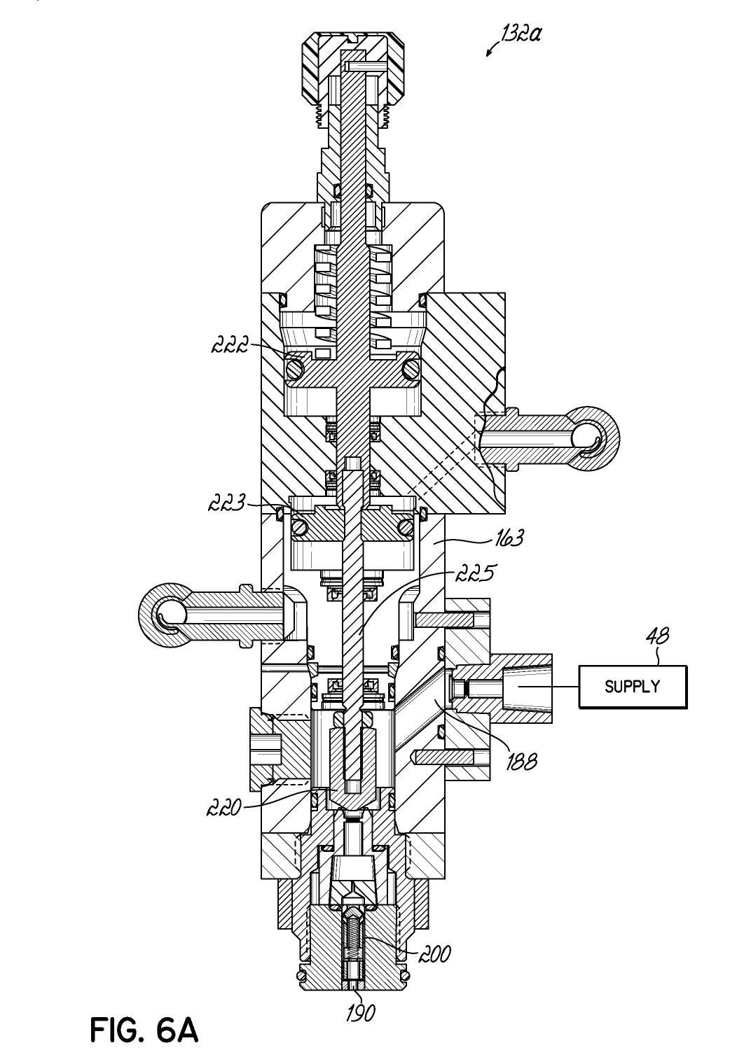

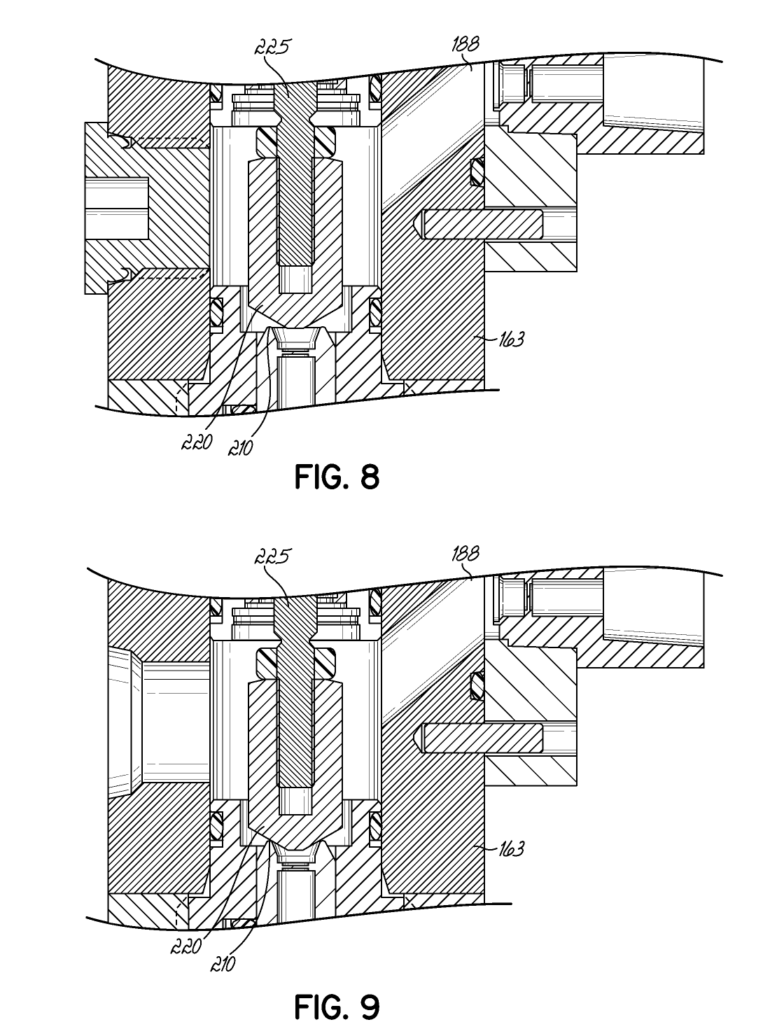

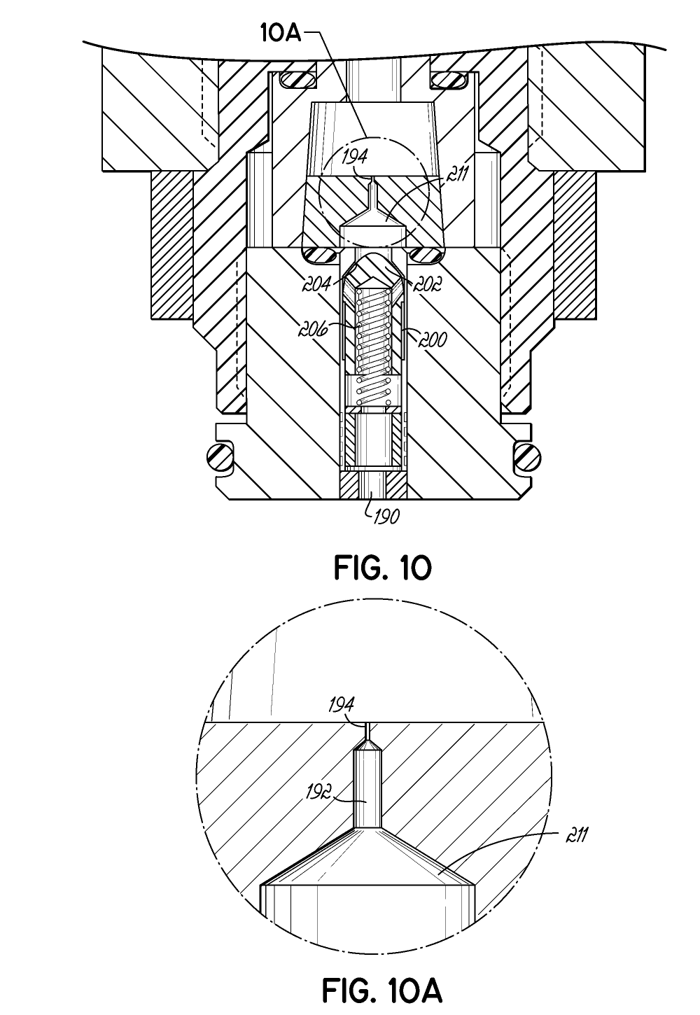

With continued reference to FIGS. 5-10A, the plunger 202 has a non-contacting relationship with the seat 204 in the first condition of the flow control element 200, while the plunger 202 has a contacting relationship with the seat 204 in the second condition (FIG. 10). The main body 163 of the gas injection module 132a has a sealing seat 210 (FIGS. 8-9) in the gas passage 192 between the inlet 188 and outlet 190 and a gas chamber 211 between the seat 204 and the control orifice 194 having a volume, in this embodiment, of about one cubic centimeter or less. A needle tip 220 (FIGS. 8-9) is movable relative to the sealing seat 210 between an open position (FIG. 8) in which the needle tip 220 is separated from the sealing seat 210 to permit the pressurized gas to flow past the sealing seat 210 and a closed position (FIG. 9) in which the needle tip 220 contacts the sealing seat 210 to block a flow of the pressurized gas. An actuator is mechanically coupled with the needle tip 220 and is adapted to move the needle tip 220 relative to the sealing seat 210 between the open and closed positions. The actuator in this specific embodiment takes the form of a pair of pistons 222, 223 (FIG. 6A) coupled to a needle 225 that is in turn coupled to the needle tip 220 and an air pressure supply 300 that supplies air pressure under the control of controller 302 to cause movement of the pistons 222, 223 so as to provide the open and closed positions. The controller 302 may be subsumed within the foam control system 58.

Other structural and functional details of the exemplary gas injection module 132a and mixing module 126 are disclosed in commonly-assigned U.S. patent application Ser. No. 11/939,150, filed Sep. 17, 2008, and the disclosure of which is hereby incorporated by reference herein in its entirety. The systems and methods of the various embodiments may use the foamed material, for example foamed polysulfide, to produce sheets, blocks and molded parts, which may be of particular benefit in aircraft manufacturing.

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, and representative apparatus and method shown and described. Accordingly, departures may be made from such details without departing from the spirit or scope of applicants' general inventive concept.

What is claimed is:

1. A method for producing a foamed material from a gas, a catalyst-containing component, and a crosslinker-containing component, the method comprising:
mixing the catalyst-containing component and the crosslinker-containing component to form a mixture;
mechanically injecting the gas into the mixture;
mixing the injected gas with the mixture; and
dispensing the mixture as the foamed material.

2. The method of claim 1 wherein the catalyst-containing component does not chemically react with the crosslinker-containing component to form the gas.

3. The method of claim 1 wherein mixing the catalyst-containing component and the crosslinker-containing component comprises:
mechanically mixing the catalyst-containing component and the crosslinker-containing component in a first mixing device to form the mixture.

4. The method of claim 3 wherein mixing the injected gas with the mixture comprises:
routing the mixture from the first mixing device to a second mixing device;
introducing the gas into the mixture in the second mixing device; and
combining the gas into the mixture in the second mixing device.

5. The method of claim 4 wherein the first mixing device is a static mixer, and mechanically mixing the catalyst-containing component and the crosslinker-containing component comprises:
moving the catalyst-containing component and the crosslinker-containing component relative to a static mixing element.

6. The method of claim 4 wherein the second mixing device is a dynamic mixer, and combining the gas into the mixture in the second mixing device comprises:
moving a dynamic mixing element relative to the mixture and the injected gas.

7. The method of claim 1 wherein the catalyst-containing component and the crosslinker-containing component are mechanically mixed in a dynamic mixer to form the mixture, and the gas is introduced into the mixture while the mixture is located in the dynamic mixer.

8. The method of claim 1 wherein the catalyst-containing component and the crosslinker-containing component are mixed in a mixing device, and mixing the catalyst-containing component and the crosslinker-containing component comprises:
feeding the catalyst-containing component through a first inlet into the mixing device; and
separately feeding the crosslinker-containing component through a second inlet distinct from the first inlet into the mixing device.

9. The method of claim 8 wherein the base resin is a silicone, an acrylic, an epoxy, a polysulfide, or a urethane.

10. The method of claim 1 wherein dispensing the mixture further comprises:
directing the foamed material into a temporary holding container; and
storing the container and the foamed material at a first temperature below room temperature.

11. The method of claim 10 wherein dispensing the mixture comprises:
heating the container and the foamed material from the first temperature to a second temperature effective to thaw the foamed material to a dispensable condition; and
dispensing the thawed foamed material from the temporary container.

12. The method of claim 10 wherein the first temperature is sufficiently low to suspend a chemical reaction between the catalyst-containing component and the crosslinker-containing component acting to cure the foamed material.

13. The method of claim 1 wherein dispensing the mixture comprises:
applying the foamed material to a first structural component of an aircraft; and
bonding the first structural component with a second structural component of the aircraft using the foamed material applied to the first component.

14. An apparatus for producing a foamed material from first and second fluid components and a gas, the apparatus comprising:
a mixing device having a mixing chamber, a first inlet communicating with said mixing chamber, a second inlet communicating with said mixing chamber, a gas port communicating with said mixing chamber, and a mixing element inside said mixing chamber, said first and second inlets configured for respectively admitting the first and second fluid components into said mixing chamber; and
a gas flow control valve coupled to said gas port and configured for introducing the gas through said gas port into said mixing chamber,
wherein said mixing element is configured to mix the first and second fluid components with the gas inside said mixing chamber to form a mixture that, when dispensed, produces the foamed material.

15. The apparatus of claim 14 further comprising:
a dispensing device operatively coupled to said mixing device and configured to dispense the mixture as the foamed material onto an application target.

16. The apparatus of claim 14 wherein said mixing device is a dynamic mixer.

17. An apparatus for producing a foamed material from first and second fluid components and a gas, the apparatus comprising:
a first mixing device having a first mixing chamber and a first mixing element inside said first mixing chamber, said first mixing element configured to mix the first and second fluid components;
a second mixing device having a second mixing chamber coupled in fluid communication with said first mixing device for receiving the first and second fluid components from said first mixing device, a second mixing element inside said second mixing chamber, and a port providing access into said mixing chamber; and
a gas flow control valve coupled with said port and configured for introducing the gas into the first and second fluid components in said second mixing chamber,
wherein said second mixing element is configured to mix the first and second fluid components with the gas inside said second mixing chamber to form a mixture that, when dispensed, produces the foamed material.

18. The apparatus of claim 17 wherein said first mixing device is a static mixer, and said second mixing device is a dynamic mixer.

19. The apparatus of claim 17 further comprising:
a dispensing device operatively coupled to said second mixing device and configured to dispense the mixture as the foamed material onto an application target.
